(19) United States
(12) Patent Application Publication
(10) Pub. No.: US 2018/0225647 A1
(43) Pub. Date: Aug. 9, 2018

(54) SYSTEMS AND METHODS FOR DETECTING RETAIL ITEMS STORED IN THE BOTTOM OF THE BASKET (BOB)

(71) Applicant: HEB Grocery Company LP, San Antonio, TX (US)

(72) Inventor: Rolando H. Cordova, San Antonio, TX (US)

(21) Appl. No.: 15/941,571

(22) Filed: Mar. 30, 2018

Related U.S. Application Data
(63) Continuation-in-part of application No. 14/681,918, filed on Apr. 8, 2015.

(51) Int. Cl. G06Q 20/20; G06N 7/00; G06K 9/00; G06T 7/70

(52) U.S. Cl. CPC G06Q 20/208; G06Q 20/202; G06N 7/005; G06T 2207/30232; G06T 7/70; G06K 2209/21; G06K 9/00771

(57) ABSTRACT

Systems and methods are described for detecting items located in the bottom of a customer's shopping cart basket. Such items are often hidden from the immediate view of cashiers and other store employees, and therefore, may not be properly accounted for during checkout. Therefore, a relatively inexpensive solution for detecting and displaying the bottom of basket area to cashiers and/or other store employees is desired so that losses associated with such items can be minimized.

### CROSS-REFERENCE TO RELATED APPLICATION

This Application is a Continuation-in-part of U.S. application Ser. No. 14/681,918 entitled “Systems and Methods for Detecting Retail Items Stored in the Bottom of the Basket (BOB),” filed on Apr. 8, 2015, which is hereby incorporated by reference herein for all purposes.

### BACKGROUND

The present disclosure generally relates to systems and methods for detecting and viewing items stored in the bottom of a customer's basket or shopping cart, which location ordinarily may not be visible to a cashier or other store employee processing checkout.

A common configuration for shopping carts, especially in the grocery store context, is to have both an upper basket, in which the customer can load most purchases, and a lower basket, in which the customer might load heavier or bulkier items. One advantage of such configuration is that customers can access the majority of their items without interference from the heavier and/or bulkier items stored in the bottom of the basket (BOB).

Because of the nature of items typically stored in BOB, it may be difficult or impossible to load such items onto a standard checkout lane. For example, such items might be too large to fit on the lane, or simply too heavy for certain customers and/or cashiers to lift and manipulate in the ways necessary to effectuate checkout. Additionally, typical checkout lane configurations often do not allow a cashier to easily assess whether items are stored in BOB. Therefore, cashiers may be forced to rely on customers to inform them that additional items are stored in BOB and need to be accounted for in such situations. Because items stored in BOB often are not in the line of sight of customers, however, customers sometimes forget about such items during checkout. Other customers may purposefully store items in BOB with the hope or expectation that they might avoid payment for those items. Thus, for a variety of reasons, customers might fail to inform the cashier that there are items stored in BOB.

Whether a customer fails to alert a cashier to items stored in BOB purposefully or otherwise, such failures can cost retailers significant amounts of money. If the cashier does not independently notice such items, the customer may leave the store without paying for the items. Therefore, it is desirable to provide systems and methods to assist a cashier or other store employee in determining whether or not there are items stored in BOB.

Various solutions have been proposed to alert employees to items in BOB, but existing solutions generally are so technically complex or cost-prohibitive as to render them unworkable for many retail establishments.

### SUMMARY

The present disclosure generally relates to systems and methods for detecting items in BOB, and more particularly, to systems and methods for providing an image of BOB to a cashier conducting retail checkout.

In one embodiment, the present disclosure provides a relatively inexpensive BOB detection system capable of displaying images of BOB to a cashier or other store employee responsible for verifying whether items are stored in BOB. This solution can optionally be implemented and contained as a single unit for ease of installation or retrofitting equipment.

In another embodiment, the present disclosure provides that the cashier or other store employee responsible for verifying whether items are stored in BOB can optionally add items to a customer's order without physically scanning or otherwise manipulating the items. Further embodiments and combinations of embodiments are described and would be apparent to those skilled in the art throughout the present disclosure.

In one embodiment, the present disclosure provides a BOB detection system capable of automatically determining whether items are stored in BOB without requiring any cashier or store employee verification.

The features and advantages of the present disclosure will be apparent to those skilled in the art. While numerous changes may be made by those skilled in the art, such changes are within the spirit of the disclosure.

### BRIEF DESCRIPTION OF THE FIGURES

Some specific example embodiments of the disclosure may be understood by referring, in part, to the following description and the accompanying figures.

FIG. 1 is a representation of a standard shopping cart and checkout lane that may be used in accordance with certain embodiments of the present disclosure.

FIGS. 2 and 3 are representations that depict a detection and image collection unit according to certain embodiments of the present disclosure.

FIG. 4 is a representation of an exemplar screen capture of a cashier terminal screen that depicts an image of BOB as it might be presented to a store employee according to certain embodiments of the present disclosure.

FIG. 5 is an exemplary block diagram of a BOB system utilizing one or more prediction models according to certain embodiments of the present disclosure.

FIG. 6 is a flow diagram of a method of determining whether an object is located in the BOB area of a shopping cart.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION OF EMBODIMENTS

The present disclosure generally relates to systems and methods for detecting items in BOB.

More particularly, the present disclosure provides systems and methods for providing an image of at least a portion of the BOB area (and optionally, other information) to a cashier conducting retail checkout. In the methods of the present disclosure, a shopping cart passes a BOB detection unit installed in a checkout lane and trigger a sensor or other detection / triggering mechanism (e.g., a reflective photo beam sensor) at the checkout lane. The sensor is coupled with an image collection device, such as a digital camera unit, in such a way that triggering the sensor causes the image collection device to capture an image of BOB. The image is then passed to the cashier processing checkout for further consideration. The present disclosure also provides methods by which a cashier must acknowledge the presence or absence of items in BOB before continuing checkout. The present disclosure also provides systems that are configured in a variety of ways so as to provide images of BOB in a simple, cost-effective manner.

The present disclosure also provides systems and methods for providing the image to a model for automatically determining whether or not an item is located in BOB. The model may allow for automatic determination after capture of the image of BOB, without the need for visual verification by the cashier or store employee. In some embodiments, the system and method may display the image to the cashier or store employee such that the cashier or store employee may identify the object located in the BOB area based on the image displayed.

In many embodiments, retailers using or providing the methods and systems of the present disclosure may be retrofitting existing equipment in order to provide the desired functionality. As described herein, the present disclosure describes the ability to package the system in a self-contained, easily installed unit that is compatible with most existing checkout systems and configurations. Additionally, any cart can be made to work with the present disclosure by, for example, affixing or providing a reflective surface on a portion of the cart that passes a reflective photo beam sensor. The reflective photo beam sensor may be any suitable unit capable of both projecting and receiving a photoelectric beam capable of transmission to and from a reflective surface. Additionally, a person of skill in the art would understand that, if desired, separate sensors could be used for emitting and receiving the signal. Similarly, the image collection device can be any device capable of capturing an image that can then be displayed to a cashier. Although a USB camera is described below in connection with the preferred embodiment, a person of skill in the art would understand that a variety of other solutions could be utilized as well. The sensor and image collection device are configured such that when the photo sensor is triggered, an image taken with the image collection device will show whether any items are stored in BOB. That image can be displayed to the cashier or other store employee responsible for that checkout lane, and the employee can be made to acknowledge whether or not items are present in BOB before proceeding with checkout.

Among the many potential advantages to the methods and compositions of the present disclosure, only some of which are alluded to herein, the methods and systems of the present disclosure may provide a more efficient, cost-effective, and/or flexible means of detecting items stored in BOB. In some embodiments, the methods and systems of the present disclosure may provide retailers greater variety and/or choice in methods of designing or retrofitting checkout lanes and terminals in ways that minimize losses for the retailers.

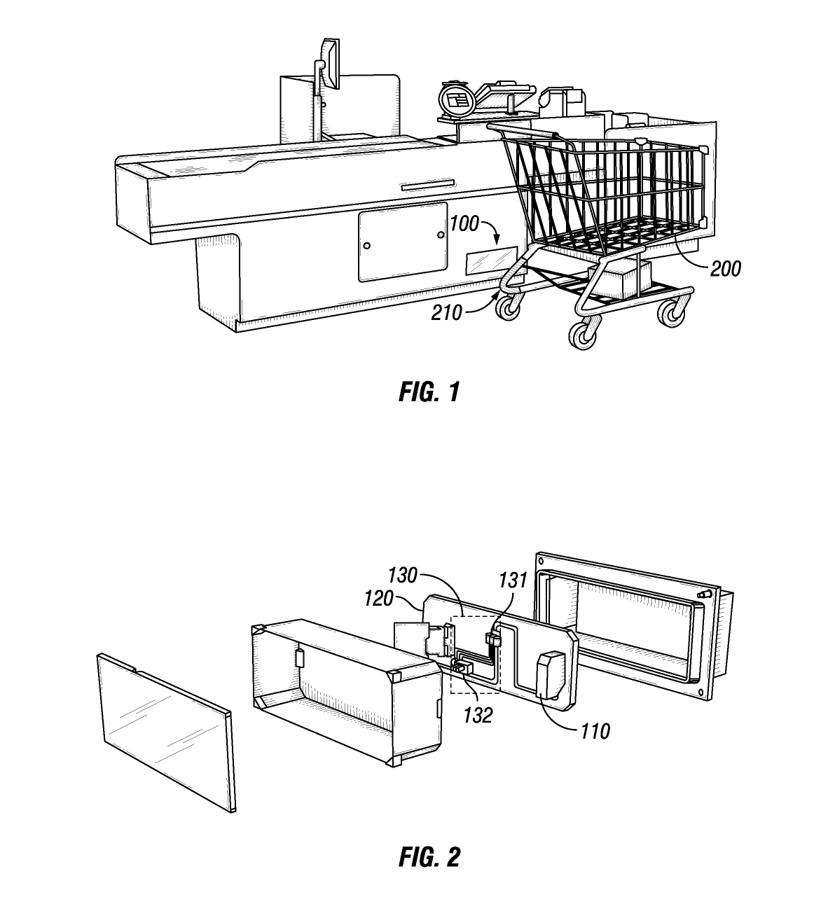

FIG. 1 illustrates an example BOB detection system 100 for detecting the presence of items stored in BOB in a standard checkout lane according to certain embodiments of the present disclosure. This example system may work with any standard shopping cart 200 that has a reflective surface 210, although as a person of skill in the art will recognize with the benefit of this disclosure, other triggering mechanisms or sensors (e.g., motion sensors, color sensors, etc.) may be used within the scope of this disclosure that do not require the presence of a reflective surface. The reflective surface can be any surface capable of reflecting a photoelectric signal, and for example, could be provided by the use of special material, paint, or a sticker affixed to that portion of the shopping cart that passes in front of the system 100.

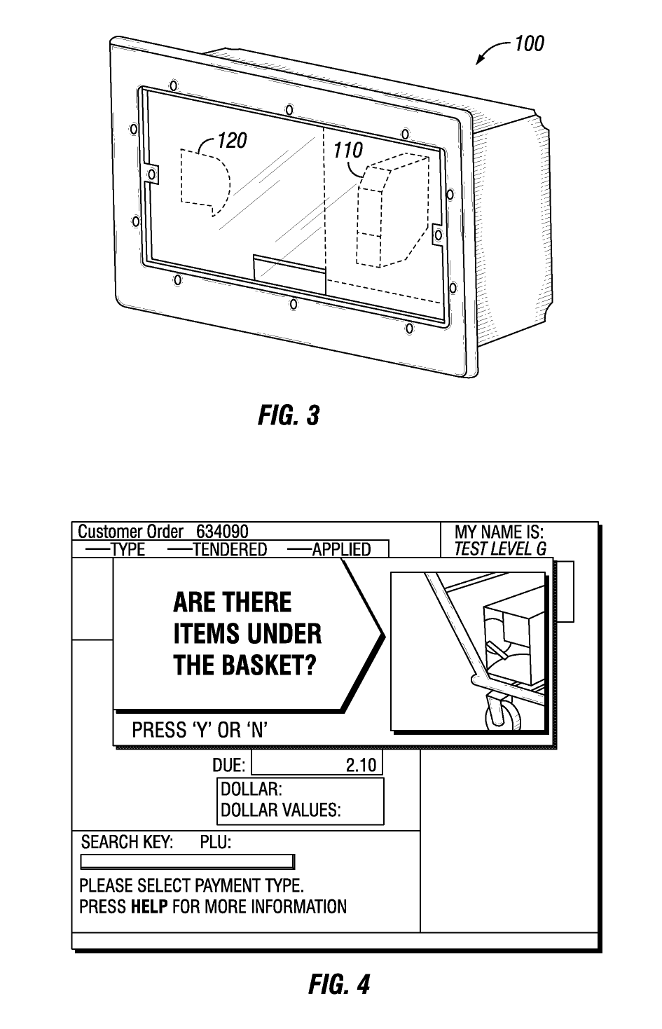

FIGS. 2 and 3 illustrate more detailed views of certain components of a preferred embodiment of the BOB detection system 100. For example, system 100 includes at least a reflective photo beam sensor 110, an image collection device 120, and a control circuit 130. Sensor 110 emits a photoelectric signal in the area in front of BOB detection system 100. When a reflective surface, such as the surface 210 of a shopping cart, passes in front of the system 100, the photoelectric signal is reflected back to the BOB detection system 100 and is detected by the receiver portion of the reflective photo beam sensor 110. Importantly, non-reflective surfaces in the area in front of the BOB detection system 100, such as children or customers without shopping carts, will have no effect on sensor 110. Additionally, a person of skill in the art will recognize that the reflective photo beam sensor 110 can be realized with any conventional sensor that is capable of both emitting and receiving photoelectric reflective signals, as well as by combining separate emitting and receiving sensors.

The control circuit 130, which may be comprised of one or more camera drivers, may be configured such that the image collection device 120 is triggered once the cashier scans an item. For example, the image collection device may be triggered when the cashier scans the first item of a customer's shopping cart. In other embodiments, the control circuit 130 may be configured such that when the reflective photo beam sensor 110 is triggered by the detection of a reflective surface in the area in front of the BOB detection system 100, the image collection device 120 captures an image of the BOB. In other embodiments, the control circuit 130 may be configured such that the image collection device 120 is triggered based on motion detection. The control circuit 130 may use a method of automatically identifying when an object is in front of the BOB detection system 100 without the cashier scanning an item or use of any reflective surface 210 as described above. Instead, in some embodiments, the control circuit 130 may use background subtraction to detect motion in the BOB area. For example, the control circuit 210 may store or access a background image where no shopping cart or other object is in view of the image collection device 120. In some embodiments, the background image may be an image where a shopping cart is in view of the image collection device 120, but no object is in the BOB area of the shopping cart.

The control circuit 210 may compare subsequent frames of the image collection device 120 to the background image and create a mask that indicates the differences between the background image and subsequent images taken. In one embodiment, if the control circuit determines an object is located in the BOB area of a shopping cart, the control circuit 210 may then trigger the image collection device to capture an image of the BOB area. As would be understood by one of ordinary skill in the art, other methods may be used as a triggering mechanism for an image collection device.

In the preferred embodiment depicted in FIG. 2, the control circuit 130 comprises an input terminal block 131 and a USB port 132. The reflective photo beam sensor is connected to the terminal block 131, which is in turn connected to both the USB port 132 and image collection device 120. The image collection device 120 can be, for example, a USB camera, which in the preferred embodiment is attached to both the terminal block 131 and USB port 132, but a person of skill in the art would understand that any standard image collection device could be utilized. Additionally, in certain embodiments, the control circuit 130 can be configured to provide an output for transmission of the captured image to the cashier or other employee responsible for checking BOB. The output can be accomplished with any suitable means of transmission, such as via USB, HDMI, VGA, or any number of other wired or wireless means of transmissions (e.g., bluetooth, wifi, etc.). In other embodiments, the image collection device 120 may handle both image collection, storage, and transmission

The image collection device 120 is mounted such that, when triggered, the captured image includes BOB and allows for visual verification as to whether or not items are present in BOB. Depending on how the BOB detection system 100 is installed, various mounting configurations are possible in order to make sure that the captured image includes BOB, as would be understood by a person of skill in the art. In the preferred embodiment illustrated in FIGS. 2 and 3, a USB camera is coupled to a reflective photo beam sensor so as to cause the USB camera to capture an image when the reflective photo beam sensor detects a reflective surface. In this specific example, it has been determined that spacing the reflective photo beam sensor 110 and image collection device 130 approximately 10-12 inches apart results in an image that consistently captures BOB without image blur or distortion. A person of skill in the art would understand that the use of alternative components or implementations might require or allow for different configurations to yield similar results. As demonstrated in FIGS. 2 and 3, the various components optionally can be packaged together in such a way that the BOB detection system 100 forms a single unit for easy install and/or retrofitting of existing equipment.

FIG. 4 is an exemplar of a potential cashier terminal screen according to the preferred embodiment of the disclosure. As depicted in FIG. 4, once an image is captured by image collection device 120, that image can be transmitted to the screen of the cashier effectuating checkout or some other employee responsible for verifying whether items are present in BOB. Together with that image, the cashier or other employee might be prompted to take affirmative action, such as pressing “y” (yes) or “n” (no), to indicate whether items are present in BOB. This can be accomplished utilizing standard software implementations and ensures that BOB can be checked consistently without requiring the customer or cashier to remember to check for items present in BOB separately. In other embodiments, the image is only transmitted when an item is in the BOB such that the affirmative action of pressing “y” or “n” is not required. Instead an image is only displayed on the cashier terminal screen when it has been determined an item is present in BOB. Affirmative action such as identifying or scanning the item in the BOB may still be required. Therefore, the systems and methods described herein may be used to minimize losses through items in BOB that otherwise may not be detected.

This capability optionally could be combined with the ability to automatically or easily acknowledge the presence of certain items that commonly are stored in BOB, such that the cashier or other employee might directly indicate the presence of such items without having to separately scan or otherwise enter identification information for such items. For example, in addition to buttons marked “y” (yes) or “n” (no) to indicate whether items are present in BOB, as described in FIG. 4, standard software and/or hardware implementations could assign additional buttons to be used for certain commonly purchased items that customers tend to store in BOB, such as soft drinks, toilet paper, diapers, etc. While the use of additional buttons is specifically referenced, one skilled in the art will recognize that any commonly utilized method for data entry would suffice to allow the cashier or other employee to add such items to a customer's order without requiring the cashier or other employee to physically scan or otherwise enter identification information.

Additionally, as one skilled in the art will recognize with the benefit of this disclosure, a BOB detection and image capture system and methods for checking items in BOB can be configured with substitutes for or a subset of the components described herein. For example, reflective photo beam sensor 110 may be replaced with two or more separate sensors, provided that both emitter and receptor sensors are used and are configured so as to sense the presence of reflective material in the area in front of the BOB detection system 100. Additionally, the image captured by image collection device 120 can be transmitted to the employee responsible for verifying the presence of items in BOB by any number of wired or wireless means.

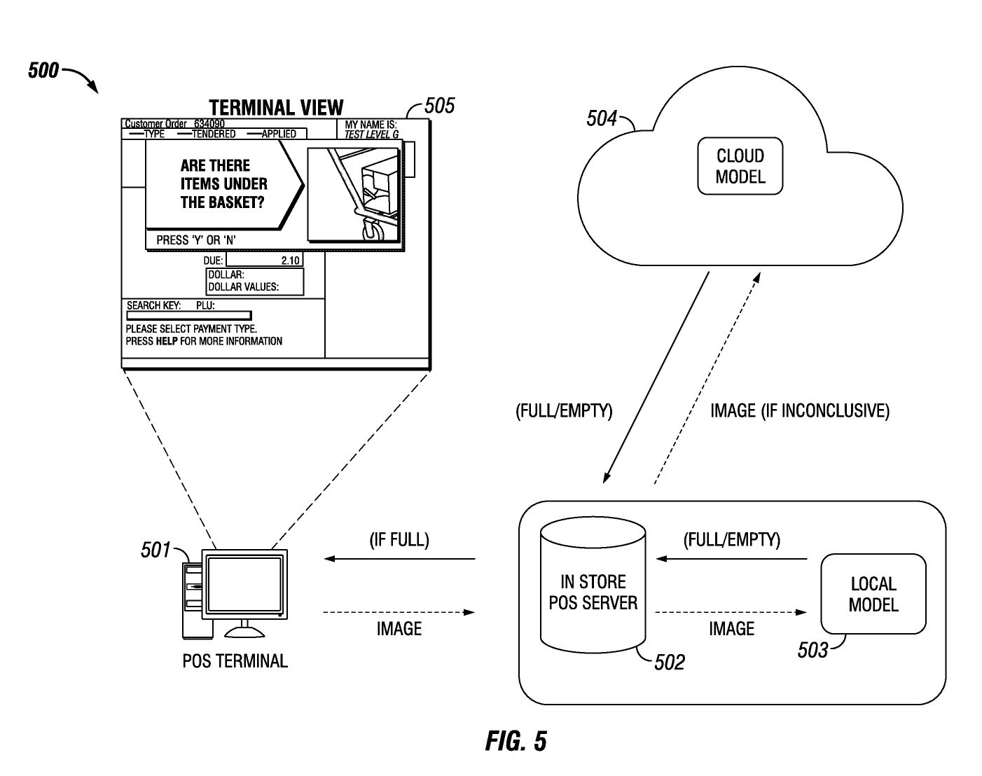

FIG. 5 depicts an exemplary BOB system 500 according to one or more aspects of the present disclosure. The BOB system 500 may include a point of sale terminal 501 which comprises a point of sale terminal display 505 as shown in FIG. 5. The BOB system 500 may be triggered, activated, initiated, powered, or otherwise started by a cashier scanning an item, a reflective surface 210, motion detection using any method as described above, or any other triggering mechanism. For example, a point of sale terminal 501 may be idle or inactive until a triggering mechanism triggers the image collection device 120. Once triggered or activated, image collection device 120 may capture an image of the BOB area of a shopping cart, as described above with respect to FIGS. 1-4. The image captured by image collection device 120 may be transmitted to a point of sale server 502. The point of sale server 502 may comprise one or more models for determining whether or not the image captured by image collection device 120 contains an object located in the BOB. For example, the point of sale server 502 may comprise a local model 503. Local model 503, and any other models comprising BOB system 500, may be pre-trained based on one or more pre-existing images, one or more images collected by the image collection device 120 or any other device, or any combination thereof. For example, local model 503 may be provided with a number of images depicting a BOB area of a shopping cart. Any number of images may be provided to local model 503 for training. For example, local model 503 may be provided with 1, 5, 10, 100, 1000, 10000, 50000, 100000, or any other number of images. The images provided to local model 503 may be collected and aggregated to comprise a database of images. The database of images may include images of an “empty” BOB area and images of a “full” BOB area with an object located therein. Additionally, the images may be pre-processed before they are ingested by the model. For example, the images may be pre-processed such that the images each have a uniform resolution in terms of width and height, for example, 299×299.

Local model 503 may be stored locally on point of sale server 502. For example, the local model 503 may be stored with the point of sale server 502 via a computer, tablet, mobile device, hard drive, or any other device integrated with the point of sale server. Local model 503 may be used to determine whether or not the image is of a BOB area of a shopping cart. Local model 503 may provide a full or empty response to point of sale server 502. Point of sale server 502 may then transmit a signal to point of sale terminal 501 based on the full or empty response provided by local model 503. For example, if local model 503 returns a “full” response, point of sale server 502 may transmit a signal to display the image captured by image collection device 120 to the point of sale terminal 501, for example, via point of sale terminal display 505. If local model 503 returns an “empty” response, point of sale server 502 may not transmit any signal and may otherwise continue normal system operation. In other embodiments, point of sale server 502 may transmit a signal to display a message to the point of sale terminal 501 indicating that no object is present in the BOB area.

In some embodiments, BOB system 500 may only comprise one prediction model, for example, local model 503. In other embodiments, BOB system 500 may further comprise a cloud model 504. Cloud model 504 may be stored on the cloud, separate or remote from point of sale server 502 and local model 503 stored with the point of sale server 502. Cloud model 504 may be similar to local model 503, but may comprise or be based upon a greater number of images than local model 510. Thus, cloud model 504 may comprise a more extensive database of images than local model 503, and thus, cloud model 504 may be more accurate than local model 503. Cloud model 504 may be a pre-trained model as described above. Additionally, cloud model 504 may be updated or trained more frequently than local model 503. For example, cloud model 504 may be trained based on additional images added or uploaded to cloud model 504 on a daily, weekly, monthly, or yearly basis. In some embodiments, cloud model 504 may continuously update based on new images or data received from image collection device 120. As a result, cloud model 504 may become more accurate as more images and data are collected. Similar to local model 503, cloud model 504 may determine whether or not an object is located in the BOB area of a shopping cart based on the database of images analyzed by the cloud model 504. Cloud model 504 may then provide a full or empty response to point of sale server 502. In some embodiments, local model 503 may be continuously or frequently updated similar to or in the exact same manner that cloud model 504 is updated. In some embodiments, local model 503 may comprise the same number of images in its database of images, rendering local model 503 just as accurate as cloud model 504.

Local model 503 and cloud model 504 may be models based on a software library, such as TensorFlow. The models may use machine learning and numerical computation. The software library may be developed in C, C++, Java, Go, Python, or any language as understood by one of ordinary skill in the art.

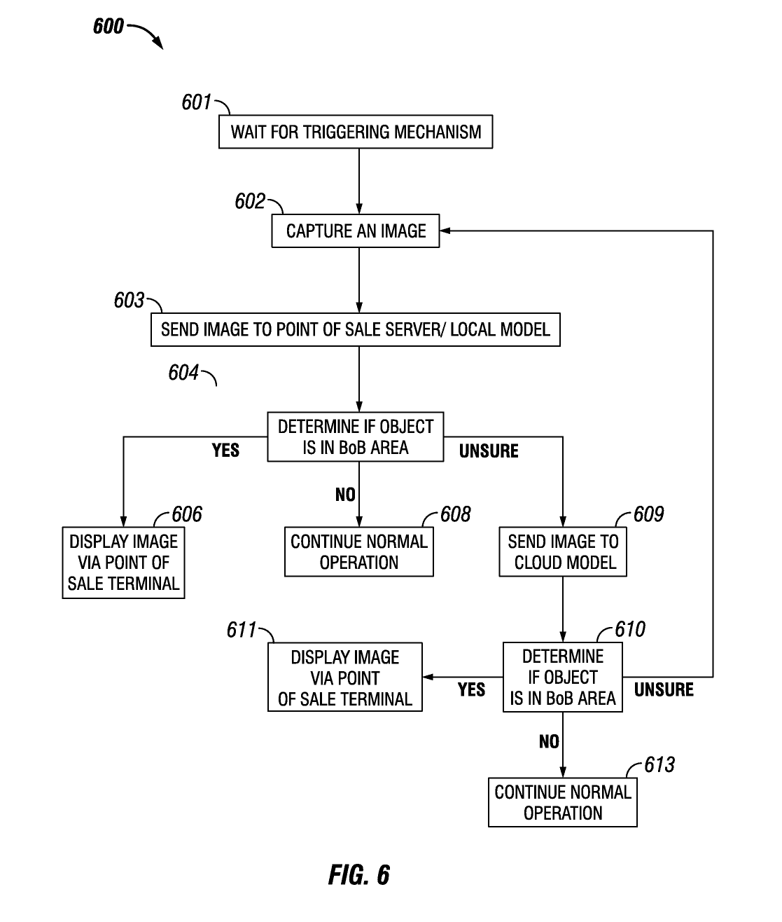

FIG. 6 is a representative flow diagram 600 of one embodiment of a BOB system 500 disclosed herein. At step 601, BOB 500 system may be idle, inactive, paused, or otherwise waiting for a triggering mechanism to be triggered. For example, in one embodiment, BOB system 500 may be activated or triggered once the cashier scans a first item. In other embodiments, BOB 500 system may be activated or triggered when a reflective surface 210 passes in front of a photo beam sensor 110, as described above with respect to FIG. 2. In other embodiments, the BOB system may be activated or triggered when control circuit 130 of image collection device 120 detects motion, using background subtraction as described above or any other method of motion detection as understood by one of ordinary skill in the art.

Once BOB system 500 is activated or triggered, at step 602, image collection device 120 may capture an image. The image may comprise a view of the BOB area of a shopping cart. In some embodiments, image collection device 120 may capture a single image. In other embodiments, image collection device 120 may capture more than one image. For example, the image collection device may capture 2, 5, 10, 20, or 100 images. The number of images captured by image collection device 120 may vary depending on the configuration of control circuit 130.

At step 603, the one or more images captured by image collection device 120 may be transmitted to a server, for example, the point of sale server 502 of FIG. 5. Point of sale server 502 may be communicatively coupled to point of sale terminal 501. Point of sale server 502 may not be physically coupled to point of sale terminal 501, but may instead be located or housed in a separate location. Point of sale server 502 may be communicatively coupled to one or more point of sale terminals 501. For example, point of sale server 502 may receive images from all point of sale terminals 501 from a single store or location, or from all point of sale terminals 501 from all stores.

At step 604, point of sale server 502 utilizes a prediction model, for example local model 503 of FIG. 5, to analyze the captured image. In some embodiments, local model 503 is stored locally thereon point of sale server 502. If local model 503 determines an object is present in the BOB area of the shopping cart, local model 503 may transmit or send a “full” response to point of sale server 502. Point of sale server 502 may then transmit a signal for point of sale terminal 501 to display the image via point of sale terminal display 505, as shown in step 607. In some embodiments, a message may be displayed via point of sale terminal display 505 indicating to the cashier that an object is present in BOB. In some embodiments, the image may only be displayed via the point of sale terminal display 505 after the message is first displayed to the cashier. In some embodiments, the cashier may be required to take action to view the image, for example, by selecting or pressing a button via point of sale terminal 501 before the image is displayed in step 607. In some embodiments, the image may be displayed once that cashier has scanned the last item of a customer's order visible to the cashier, for example, once the cashier presses a “total” button at the point of sale terminal, so as to not interrupt the flow of scanning the customer's items. After the image is displayed to the cashier, the cashier may be required to take additional action, such as scanning the item, entering an item code into the point of sale terminal 501, or any other action to identify the item in the BOB area of the shopping cart.

If local model 503 determines there is no object in the BOB area of a shopping cart, local model 503 may transmit or send an “empty” response to point of sale server 502. As a result, point of sale server 502 may not transmit a signal to point of sale terminal 501 to display an image, and instead point of sale server 502 may continue with normal operation. In some embodiments, after the cashier presses a “total” button at the point of sale terminal 501, the cashier will not see any image, and will know that no object is present in the BOB area of the shopping cart. In other embodiments, the cashier may view a message via point of sale display 505 indicating that no objects are present in the BOB area.

Local model 503 may be unable to determine to whether or not an object is present in the BOB of a shopping cart at step 604. If local model 503 is unable to make a determination, point of sale server 502 may transmit the image to cloud model 504, as shown in step 609. At step 610, cloud model 504 may then determine whether or not an object is present in the BOB area. If cloud model 504 determines an object is present in the BOB area of the shopping cart, cloud model 504 may transmit or send a “full” response to point of sale server 502. Point of sale server 502 may then transmit a signal to point of sale terminal 501 to display the image via point of sale terminal display 505, as shown in step 612. In some embodiments, a message may be displayed via point of sale terminal display 505 indicating to the cashier that an object is present in BOB, and the image may only be displayed via point of sale terminal display 505 after the message is first displayed to the cashier. In some embodiments, the cashier may be required to take action to view the image, for example, by selecting or pressing a button via point of sale terminal 501 before the image is displayed in step 607. In some embodiments, the image may be displayed after the cashier has scanned the last item of a customer's order visible to the cashier, for example, once the cashier presses a “total” button at the point of sale terminal, so as to not interrupt the flow of scanning the customer's items. After the image is displayed to the cashier, the cashier may be required to take additional action, such as scanning the item, entering an item code into point of sale terminal 501, or any other action to identify the item in the BOB area of the shopping cart.

If cloud model 504 determines there is no object in the BOB area of the shopping cart, cloud model 504 may send an “empty” response to point of sale server 502. As a result, point of sale server 502 may not transmit a signal to point of sale terminal 501 to display an image and point of sale server 502 may continue normal operation. In some embodiments, after the cashier presses a “total” button at the point of sale terminal 501, the cashier will not see any image, and will know that no object is present in the BOB area of the shopping cart. In other embodiments, the cashier may see a message via point of sale display 505 indicating that no objects are present in the BOB area.

In some embodiments, local model 503, cloud model 504, or both may be configured to provide a “full” or “empty” response along with a probability number to point of sale server 502. The probability number may be indicative of the certainty or confidence of local model 503, cloud model 504, or both in determining the “full” or “empty” response. The probability number may be relative to a scale, for example, a scale of 0 to 100. In some embodiments, point of sale server 502 may evaluate the probability number provided by local model 503, cloud model 504, or both before transmitting a signal to point of sale terminal 501. For example, point of sale server 502 may compare the probability number to a certain threshold number, and only transmit a signal to point of sale terminal 501 to display the image if the probability number meets or exceeds the threshold number. For example, in some embodiments, the threshold number may be 50, 51, 70, 75, or any other number on a specified scale. If the probability number is below the threshold number, point of sale server 502 may transmit a signal to point of sale terminal 501 to not display the image, and instead transmit a signal that returns the BOB system to step 601 or step 602.

Therefore, the present disclosure is well adapted to attain the ends and advantages mentioned, as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method of detecting an object in a bottom of basket area of a shopping cart comprising:
capturing an image of at least a portion of the bottom of basket area in response to an activation of a triggering mechanism;
transmitting the image to a server;
attempting to make a determination, using a first prediction model, whether an object is present in the image of the portion of the bottom of basket area;
if the first prediction model is able to make the determination whether an object is present in the image of the portion of the bottom of basket area, transmitting a signal to a point of sale terminal based, at least in part, on the determination by the first prediction model; and
displaying the image of the portion of the bottom of basket area based, at least in part, on the signal transmitted to the point of sale terminal.

2. The method of claim 1, wherein if the first prediction model is unable to determine whether an object is present in the image of the portion of the bottom of basket area, further comprising:
attempting to make a determination, using a second prediction model, whether an object is present in the image of the portion of the bottom of basket area.

3. The method of claim 2, wherein the second prediction model is stored on a cloud remote from a point of sale terminal.

4. The method of claim 1, wherein the first prediction model is stored on a server coupled to the point of sale terminal.

5. The method of claim 1, further comprising:
completing a customer's order based on the displayed image of the portion of the bottom of basket area.

6. The method of claim 1, wherein the triggering mechanism is scanning a first item of a customer's order.

7. The method of claim 1, further comprising:
updating the first prediction model, the second prediction model, or both using the image of the portion bottom of basket area, the image captured by an image collection device adjacent to the bottom of basket area.

8. The method of claim 1, wherein attempting to make the determination using the first prediction model, second prediction model, or both, comprises comparing the image of the portion of the bottom of basket area to one or more previous captured images of at least a portion of the bottom of basket area.

9. The method of determining whether an object is located in a bottom of basket area comprising:
capturing an image of at least a portion of the bottom of basket area in response to an activation of a triggering mechanism;
determining, using a first prediction model, a first probability number that an object is located in the image of the portion of the bottom of basket area;
comparing the probability number determined by the first prediction model, to a first threshold number;
if the first probability number is equal to or greater than the first threshold number, transmitting a signal to a point of sale terminal to display the image of the portion of the bottom of basket area.

10. The method of claim 9, wherein if the probability number determined by the first prediction model is less than the first threshold number, further comprising:
determining, using a second prediction model, a second probability number that an object is located in the image of the portion of the bottom of basket area;
comparing the second probability number determined by the second prediction model, to a second threshold number;
if the second probability number is equal to or greater than the second threshold number, transmitting a signal to the point of sale terminal to display the image of the portion of the bottom of basket area.

11. The method of claim 10, wherein if the second probability number determined by the second prediction model is less than the second threshold number, further comprising:
transmitting a signal to the point of sale terminal to capture another image of at least a portion of the bottom of basket area.

12. The method of claim 9, wherein the first prediction model is stored on a server coupled to a point of sale terminal.

13. The method of claim 10, wherein the second prediction model is stored on a cloud remote from the point of sale terminal.

14. The method of claim 9, wherein the first prediction model is comprised of a database of images of at least portions of bottom of basket areas.

15. The method of claim 10, wherein the second prediction model is comprised of a larger database of images than the database of images associated with the first prediction model.

16. A system for detecting an object in a bottom of basket area, comprising:
an image collection device;
a point of sale terminal coupled to the image collection device, wherein the point of sale terminal further comprises a display;
a point of sale server coupled to the point of sale terminal, wherein the point of sale server comprises a first prediction model, and wherein the point of sale server is operable to transmit a signal to the point of sale terminal.

17. The system of claim 16, further comprising:
a cloud server coupled to the point of sale server, wherein the cloud server comprises a second prediction model, and wherein the cloud server is operable to transmit a signal to the point of sale server.

18. The system of claim 16, wherein the point of sale server transmits a signal to the point of sale terminal to display the image, based on a response provided by the first prediction model.

19. The system of claim 17, wherein the cloud server transmits a signal to the point of sale server to display the image, based on a response provided by the second prediction model.

20. The system of claim 16, wherein the image collection device captures an image, and wherein the first prediction model determines whether an object is located in the bottom of basket area based on the image.
